(19) United States
(12) Patent Application Publication
(10) Pub. No.: US 2012/0015137 A1
(43) Pub. Date: Jan. 19, 2012

(54) PAPER-BASED COMPOSITE MATERIAL

(75) Inventor: Hok Cheung Ho, Kwai Chung (CN)

(73) Assignee: PAPER ART PRODUCT LTD, Kwai Chung, Hong Kong (CN)

(21) Appl. No.: 13/060,496

(22) PCT Filed: Oct. 21, 2008
(86) PCT No.: PCT/CN2008/001771

§ 371 Date: Jun. 24, 2011

(30) Foreign Application Priority Data
Aug. 29, 2008 (CN) 200820189419.6

(51) Int. Cl. B32B 27/12; B05D 1/16; B32B 27/40

(52) U.S. Cl. 428/90; 428/425.1; 442/286; 442/394

(57) ABSTRACT

A paper-based composite comprises an interface layer (1) and a surface layer (2) which is bond on at least one surface of the interface layer (1). The interface layer (1) is made by foaming and curing polyurethane with paper cords (3) which are made by winding paper blended with a resin or adhesive.

### TECHNICAL FIELD

The present invention relates to a paper-based composite material useful for manufacturing automobile interior parts such as ceiling.

### BACKGROUND ART

Existing automobile interior parts and ceiling are made of layered composite materials which are generally composed of two to three layers. The interface layer of the layered composite materials is foamed polyurethane layer, which is sandwiched on both sides by non-woven fabric or suede layers. Although the polyurethane layer has the advantages of light weight and good heat insulation, it suffers from the disadvantages of low strength and poor curing stability. In order to address the issue of strength, attempts have generally been made to supplement the interface layer with some fibrous materials such as vegetable fibers, glass fibers or the like to enhance its strength. However, this process permits no easy moulding and results in low production efficiency. Moreover, as these fibers are thin and short, the overall rigidity of the layered materials remains low. Additionally, the problem of poor curing and manufacturing stability still prevails.

### SUMMARY OF THE INVENTION

The object of the present invention is to provide a paper-based composite material with high strength, good curing stability and easy moulding ability.

In order to solve the above technical issues, the following technical solution is adopted in the present invention. A paper-based composite material is provided that comprises an interface layer and a surface layer adhering to at least one side of the interface layer. The interface layer is made by foaming and curing polyurethane added with paper cords, and the paper cords are made by winding paper blended with a resin or adhesive.

Using the above said structure, the paper cords made by winding paper blended with a resin or adhesive according to the present invention is light-weighted, has good mouldability, and can be readily incorporated into polyurethane. The integral paper-based composite material has good overall rigidity, can effectively increase the curing stability of polyurethane and reduce the expansion of polyurethane, and is not easy to deform. Moreover, it allows for easy moulding and high production efficiency. Such paper-based composite material according to the present invention is simple to manufacture and can be widely used in automobile interior parts such as ceiling, demonstrating its high practicability and promotional value.

### BRIEF DESCRIPTION OF THE DRAWINGS

The present invention will now be further illustrated in the following detailed description of the invention in conjunction with the accompanied drawings, which shall not be deemed as constituting any limitation to the present invention. In the drawings:

FIG. 1 is a cutaway view of a paper-based composite material;

FIG. 2 is a cutaway view along the A-A line in FIG. 1; and

FIG. 3 is a cross-sectional view of another structure of paper cords.

### DETAILED DESCRIPTION OF THE INVENTION

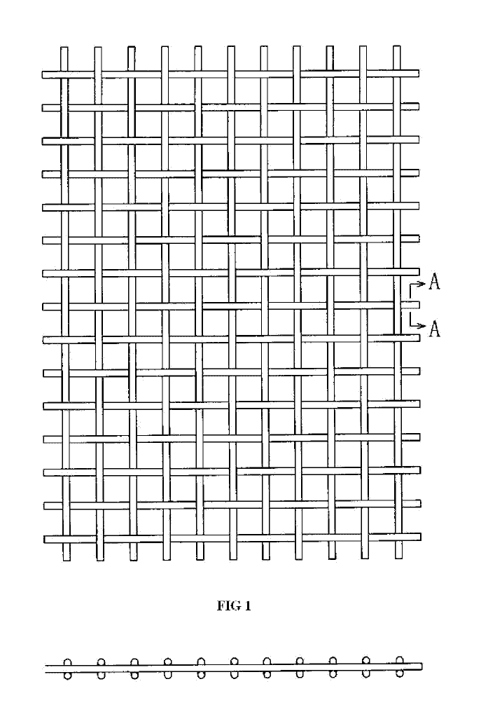

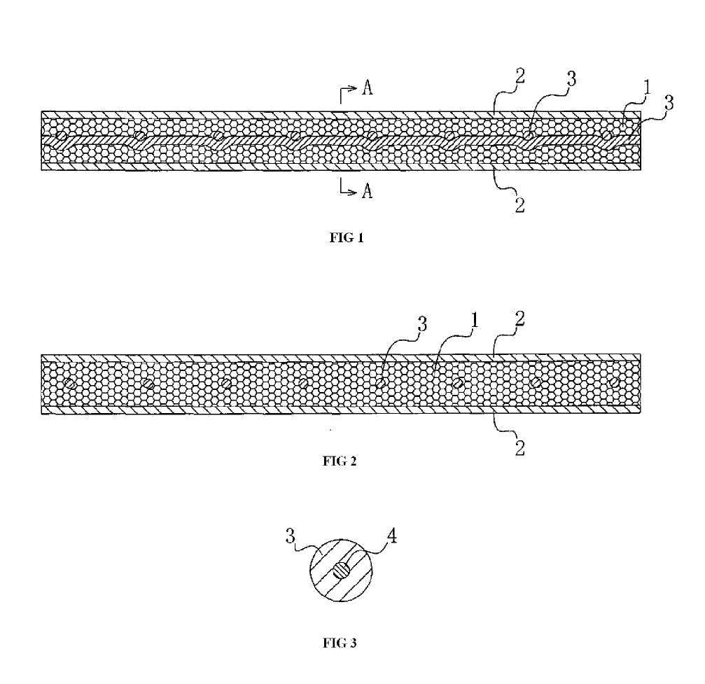

As shown in FIG. 1 and FIG. 2, a paper-based composite material comprises an interface layer 1 and a surface layer 2 adhering to at least one side of the interface layer 1. Said surface layer 2 adhering to one side of the interface layer may be of non-woven fabric and serves the purpose of reinforcement and bonding, and this surface layer can be omitted. Said surface layer 2 adhering to the other side of the interface layer can be of decorative woven fabric, flock, PU decorative layer, self-skinning polyurethane and serves the purpose of decoration. Said interface layer 1 is made by foaming and curing polyurethane added with paper cords 3, which run through the whole polyurethane layer. Said paper cords 3 are made by winding paper blended with a resin or adhesive. The paper used can be a kraft paper or composite paper. Said paper cords 3 made by winding paper blended with a resin or adhesive are light-weighted and strong.

Said paper cords 3 inside said interface layer 1 are woven into a web with the laterally and longitudinally positioned paper cords interweaving with each other to form a paper web. The interface layer 1 formed by foaming with said paper cords 3 has a better strength.

As shown in FIG. 3, inside said paper cords 3 there is provided a fiber reinforcing core 4 which is added in the course of winding said paper cords 3 and bonds with the paper through the resin or adhesive. The fiber reinforcing core 4 enhances the rigidity of said paper cords 3, resulting in better rigidity of the whole paper-based composite material. Said fiber reinforcing core 4 is preferably of vegetable fiber or glass fiber.

In summary, while the preferred embodiments of the present invention have been exemplified above, it is to be noted that various changes and modifications will be apparent to those skilled in the art. Such changes and modification, unless they depart from the spirit and scope of the present invention, are to be construed as being included within the scope of the present invention.

1. A paper-based composite material, comprising an interface layer and a surface layer adhering to at least one side of the interface layer, characterized in that said interface layer is made by foaming and curing polyurethane added with paper cords, and the paper cords are made by winding paper blended with a resin or adhesive.

2. The paper-based composite material according to claim 1, characterized in that said paper cords inside said interface layer are woven into a web.

3. The paper-based composite material according to claim 1, characterized in that inside said paper cords there is provided a fiber reinforcing core which bonds with the paper through the resin or adhesive.

4. The paper-based composite material according to claim 1, characterized in that said paper is a kraft paper or composite paper.

5. The paper-based composite material according to claim 3, characterized in that said fiber reinforcing core is of vegetable fiber or glass fiber.

6. The paper-based composite material according to claim 1, characterized in that said surface layer is of non-woven fabric.

7. The paper-based composite material according to claim 1, characterized in that said surface layer is of decorative woven fabric, flock, PU decorative layer, self-skinning polyurethane.
